(19) United States
(12) Patent Application Publication
(10) Pub. No.: US 2015/0173380 A1
(43) Pub. Date: Jun. 25, 2015

(54) METHOD AND APPARATUS FOR THE AMPLIFICATION OF ELECTRICAL CHARGES IN BIOLOGICAL SYSTEMS OR BIOACTIVE MATTER USING AN INDUCTIVE DISK WITH A FIXED GEOMETRIC TRACE

(71) Applicant: Pier RUBESA, Grattavache (CH)

(72) Inventor: Pier Rubesa, Grattavache (CH)

(21) Appl. No.: 14/413,192

(22) PCT Filed: Jul. 5, 2013
(86) PCT No.: PCT/IB2013/055508

§ 371 Date: Jan. 6, 2015

(30) Foreign Application Priority Data
Jul. 6, 2012 (EP) 12175462.6

(51) Int. Cl. A23B 7/015

(52) U.S. Cl. CPC A23B 7/015; A23V 2002/00

(57) ABSTRACT

an inductive disk or plate containing an etched, printed or glued conductive material in the form of a coil having a specific geometric shape, arranged such that the natural flow of electrically charged particles, such as electrons or protons, that are plentiful in biological systems, activate the inductive properties of the inductive disk or antenna, and thus generate an induced electromagnetic signal in the coil.

### TECHNICAL FIELD

The present invention relates to a spiral antenna or self inductive disk that may be used to enhance, reinforce or amplify structured electromagnetic signals, called bioharmonic signals, which are inherent to all biological systems.

### BACKGROUND CONCEPTS

### Definitions

The designation bioharmonic signal is used to identify a natural wave phenomenon, or in other words, a low frequency electrical waveform that is related to the physical and or behavioral state of a biological system. Wherein the origin of the term bio is used as a short form for the term biology or biological, relating to the properties of living systems, and the term harmonic is used in relation to individual frequency components of a complex waveform.

The term biological system is used to signify any living or biological organism or system such as a protein, cell, organ, plant, animal, or human.

The term bioactive matter is used to signify any matter or material that is derived from or is a component to a biological system.

The term bioharmonic detection system is used to signify a novel electronic device that is capable of detecting low frequency electric field changes in a biological system such as a human, animal or plant.

### Vibration and the Electromagnetic Spectrum

A spectrum is a condition that is not limited to a specific set of values but can vary infinitely within a continuum. The term refers to a plot of intensity or power as a function of frequency or wavelength, also known as a spectral density, and now applies to any signal that can be measured or decomposed along a continuous variable. Some typical examples include: the energy in electron spectroscopy, the mass to charge ratio in mass spectrometry, or the harmonic content of sound waves. The term spectrum is also used to refer to a graphical representation of the frequency components that make up a complex waveform.

### Electromagnetic Fields

The electromagnetic field is defined as the field produced by moving charges. Electromagnetic radiation (EM radiation or EMR) is a form of energy emitted and absorbed by charged particles, which exhibits wave-like behavior as it travels through a medium (i.e. space). At different frequency bands we have unique manifestations of energy:

At the upper end of the electromagnetic spectrum, the gamma range (10⁻¹² m), we have the vibrations of atomic nuclei. In the x-ray band (10⁻¹⁰ nm) we find the vibrations of atoms. In the ultra-violet range (10⁻⁸nm), the vibrations of molecules and ions. In the visible range (0.5×10⁻⁶) energy manifests as light.

An electron in an excited molecule or atom that descends to a lower energy level emits a photon of light equal to the energy difference. Since the energy levels of electrons in atoms are discrete, each element and each molecule emits and absorbs its own characteristic frequencies.

In the infra-red band (10⁻⁵) energy manifests as heat. Lower still in the gigahertz and microwave band (10⁻²) we have, what is commonly misquoted as <<electromagnetic radiation>> of communication systems, radar, mobile phones, wireless networks, etc., lower still along the electromagnetic frequency spectrum, we find radio waves.

The region of vibrational frequencies lower than the radio band, less than 500 kHz, we can call the <<extended audio frequency range>>. In this region we have the ultrasonic band (frequencies greater than 20 kHz), audible sound (16 Hz-20 kHz), and infrasound (less than 16 Hz). Over this range, energy manifests as a mechanical force, whereby it moves the molecular and atomic position of matter in space without disturbing it's structure. The extended audio frequency range consists of a wide bandwidth which includes the vibrations generated by mechanical action, tectonic movement, weather and ocean currents, the movement of planets, stars and galaxies, and biological systems (i.e. speech, birdsong, animal sounds, heartbeat, respiration, etc.).

The lower frequency band of the electromagnetic spectrum, less than 500 kHz, can generate a field of physical or mechanical influence on matter, which for example may be observed by moon's effects on ocean tides caused by gravitational waves, and ultrasound can be applied to modify the mechanical properties of cells used in biological research or to eliminate tartar buildup on tooth enamel.

The common approach in defining phenomena across the electromagnetic spectrum is based in principle by our interest in a specific application. We are more or less tied to a particular range of the energy spectrum, and the perception we have in our frame of reference regarding that interest is somehow limited to this particular range. Such particular range is for example the electromagnetic spectrum as applied to communications systems, the visible light band, the X-ray band, the gamma range, the sound spectrum, etc. It is very rare to find references related to interactions that involve multiple ranges of the electromagnetic spectrum.

FIG. 0.1 The Electromagnetic Spectrum

### Electric Charge

Electric charge is a physical property of matter that causes it to experience a force when it is near other electrically charged matter. Electric charge comes in two types, called positive and the other negative. Two positively charged substances, or objects, experience a mutual repulsive force, as do two negatively charged objects. Positively charged objects and negatively charged objects experience an attractive force.

The electric charge is a fundamental conserved property of some subatomic particles, which determines their electromagnetic interaction. Electrically charged matter is influenced by, and produces, electromagnetic fields. The interaction between a moving charge and an electromagnetic field is the source of the electromagnetic force, which is one of the four fundamental forces.

Charge is the fundamental property of forms of matter that exhibit electrostatic attraction or repulsion in the presence of other matter. Electric charge is a characteristic property of many subatomic particles. The charges of free-standing particles are integer multiples of the elementary charge e, we say that electric charge is quantized, that is, it comes in multiples of individual small units called the elementary charge, e, (approximately equal to 1.602×10⁻¹⁹ coulombs). The proton has a charge of e, and the electron has a charge of -e. The SI unit of electric charge is the coulomb (C).

Coulomb's law quantifies the electrostatic force between two particles by asserting that the force is proportional to the product of their charges, and inversely proportional to the square of the distance between them.

The electric charge of a macroscopic object is the sum of the electric charges of the particles that make it up. This charge is often small, because matter is made of atoms, and atoms typically have equal numbers of protons and electrons, in which case their charges cancel out, yielding a net charge of zero, making the atom and thus the object electrically neutral.

### Electromagnetic Induction, Charge and Force

Electromagnetic induction is the production of an electric current across a conductor moving through a magnetic field. It underlies the operation of generators, transformers, induction motors, electric motors, synchronous motors, and solenoids.

Electromotive force (EMF) is produced around a closed conducting path and is proportional to the rate of change of the magnetic flux through any surface bounded by that path. An electric current will be induced in any closed circuit when the magnetic flux through a surface bounded by the conductor changes. This applies whether the field itself changes in strength or the conductor is moved through it.

Electrostatic induction is a redistribution of electrical charge in an object, caused by the influence of nearby charges. Electrostatic induction should not be confused with electromagnetic induction as both are often referred to as ‘induction’. A normal uncharged object contains equal numbers of closely spaced positive and negative electric charges, thus no part of the material has a net electric charge. The positive charges are related to the atoms' nuclei which are bound into the structure of matter and are not free to move, while the negative charges are the atoms' electrons. In electrically conductive objects such as metals, some of the electrons are able to move freely about in the object.

When an electrical charge is brought near an uncharged and electrically conducting object, such as a piece of metal, the force of the nearby charge causes a movement of these charges. For example, if a positive charge is brought near the object, the free electrons in a conductive material will be attracted toward it and move to the side of the charge. When the electrons move out of an area, they leave an unbalanced positive charge in the atomic nuclei. This results in a region of negative charge on the object nearest to the external charge, and a region of positive charge on the part away from it. These are called induced charges. If the external charge is negative, the polarity of the charged regions will be reversed. Since this process is just a redistribution of the charges that were already in the object, the object has no net charge. This induction effect is reversible; if the nearby charge is removed, the attraction between the positive and negative internal charges cause them to settle to their original position.

However, the induction effect can also be used to place a net charge on an object. If the charged object is momentarily connected through a conductive path to electrical ground, which is essentially a reservoir of both positive and negative charges, some of the negative charges in the ground will flow into the object, under the attraction of the nearby positive charge. When the contact with ground is broken, the object is left with a net negative charge. An opposite permanent charge on an object can be achieved if it is grounded from the opposite edge to that which is bearing the external induction charge.

The movement of charge is caused by the force exerted by the electric field of the external charged object. As the charges in an object continue to separate, the resulting positive and negative regions create their own electric field, which opposes the field of the external charge. This process continues until an equilibrium is reached in which the induced charges are exactly equivalent to cancel out the external electric field throughout the interior of the object. In any conductive object there is a very large number of mobile charge carriers (electrons), enough to cancel out extremely large external electric fields.

### Induced Charges Reside on the Surface

Since the mobile charges in the interior of a conductive object are free to move in any direction, there can never be a static concentration of charge inside the object; if there was, opposite polarity would be attracted and would neutralise the charge. Therefore, mobile charges move under the influence of external charge until they reach the surface of a conductive object and collect there, where they are constrained from moving by the boundary of the object. This establishes an important principle that electrostatic charges on conductive objects reside on the surface of the object. External electric fields induce surface charges on conductive objects that exactly cancel the field within. Since the field is the gradient of the electrostatic potential, the potential (voltage) throughout a conductive object is constant.

### Induction in Dielectric Objects

A similar induction effect occurs in nonconductive (dielectric) objects, and is responsible for the attraction of nonconductive objects, such as paper, styrofoam, and biological matter to static electric charges. In non-conductive materials, the electrons are bound to atoms or molecules and are not free to move about the object as in conductors; however they can be displaced within the molecules themselves. If a positive charge is brought near a nonconductive object, the electrons in each molecule are attracted toward it, and move to the side of the molecule facing the charge, while the positive nuclei are repelled and move slightly to the opposite side of the molecule. Since the negative charges are now closer to the external charge than the positive charges, their attraction is greater than the repulsion of the positive charges, resulting in a small net attraction of the molecule toward the charge. This is called polarization, and the polarized molecules are called dipoles.

In chemistry and physics, the inductive effect is an experimentally observable effect of the transmission of charge through a chain of atoms in a molecule by electrostatic induction. The net polar effect exerted by a substituent is a combination of this inductive effect and the mesomeric effect.

The electron cloud in a σ-bond between two unlike atoms is not uniform and is slightly displaced towards the more electronegative of the two atoms. This causes a permanent state of bond polarization, where the more electronegative atom has a slight negative charge (δ−) and the other atom has a slight positive charge (δ+). If the electronegative atom is then joined to a chain of atoms, the positive charge is relayed to the other atoms in the chain. This is the electron-withdrawing inductive effect, also known as the −I effect. Some groups are less electron-withdrawing and are therefore considered as electron-releasing. As the induced change in polarity is less than the original polarity, the inductive effect rapidly dies out, and is significant only over a short distance. The inductive effect is permanent but feeble, as it involves the shift of strongly held σ-bond electrons, and other stronger factors may overshadow this effect. The inductive effect may be caused by some molecules also whose relative inductive effects are measured with reference to hydrogen. Inductive effects in molecules can be measured through the Hammett equation.

The inductive effect can also be used to determine whether a molecule is stable or unstable depending on the charge present on the atom. If an atom has a positive charge and is related to the −I group, its charge becomes ‘amplified’ and the molecule becomes more unstable. Similarly, if an atom has a negative charge and is attached to a +I group its charge becomes ‘amplified’ and the molecule becomes more unstable. In contrast to the above two cases, if an atom has a negative charge and is attached to a −I group its charge becomes ‘de-amplified’ and the molecule becomes more stable. Similarly, if an atom has a positive charge and is attached to a +I group its charge becomes ‘de-amplified’ and the molecule becomes more stable. The explanation for the above is given by the fact that more charge on an atom decreases stability and less charge on an atom increases stability.

The inductive effect also plays a vital role in deciding the acidity and basicity of a molecule. Groups having +I effect attached to a molecule increases the overall electron density on the molecule and the molecule is able to donate electrons, making it basic. Similarly groups having −I effect attached to a molecule decreases the overall electron density on the molecule making it electron deficient which results in its acidity. As the number of −I groups attached to a molecule increases, its acidity increases; as the number of +I groups on a molecule increases, its basicity increases.

### Atoms and Ions

An ion is an atom (or group of atoms) that has lost one or more electrons, giving it a net positive charge (cation), or that has gained one or more electrons, giving it a net negative charge (anion). Monatomic ions are formed from single atoms, while polyatomic ions are formed from two or more atoms that have been bonded together, in each case yielding an ion with a positive or negative net charge.

During the formation of macroscopic objects, usually the constituent atoms and ions will combine in such a manner that they form structures composed of neutral ionic compounds electrically bound to neutral atoms. Thus macroscopic objects tend toward being neutral overall, but macroscopic objects are rarely perfectly net neutral.

There are times when macroscopic objects contain ions distributed throughout the material, rigidly bound in place, giving an overall net positive or negative charge to the object. Macroscopic objects made of conductive elements, can take on or give off electrons, and then maintain a net negative or positive charge indefinitely. When the net electric charge of an object is non-zero and motionless, the phenomenon is known as static electricity.

Non-conductive materials can be charged to a significant degree, either positively or negatively. Charges can be taken from one material and moved to another material, leaving an opposite charge of the same magnitude behind. The law of conservation of charge always applies, giving the object from which a negative charge has been taken a positive charge of the same magnitude, and vice-versa.

Even when an object's net charge is zero, charge can be distributed non-uniformly in the object (e.g., due to an external electromagnetic field, or bound polar molecules). In such cases the object is said to be polarized. The charge due to polarization is known as bound charge, while charge on an object produced by electrons gained or lost from outside the object is called free charge. The motion of electrons in conductive metals in a specific direction is known as electric current.

### Absorption Spectrum

The absorption spectrum is a spectroscopic technique that measures the interaction between electromagnetic radiation and a sample. As a sample is exposed to a radiating field, the intensity of energy (photon) absorption will vary as a function of frequency or wavelength. A material's absorption spectrum is the fraction of incident radiation absorbed by the material over a range of frequencies.

The frequencies where absorption lines occur, as well as their relative intensities, primarily depend on the electronic and atomic structure of the molecule. The frequencies will also depend on the interactions between molecules in the sample, the crystal structure in solids, and on several environmental factors such as temperature, pressure, and the presence of electromagnetic fields. The lines will have a width and shape that are primarily determined by the spectral density or the density of states of the system.

Absorption lines are typically classified by the nature of the quantum mechanical change induced in the molecule or atom. Rotational lines, for instance, occur when the rotational state of a molecule is changed. Rotational lines are typically found in the microwave spectral region. Vibrational lines correspond to changes in the vibrational state of the molecule and are typically found in the infrared region. Electronic lines correspond to a change in the electronic state of an atom or molecule and are typically found in the visible and ultraviolet region. X-ray absorptions are associated with the excitation of inner shell electrons in atoms. These changes can also be combined (e.g. rotation-vibration transitions), leading to new absorption lines at the combined energy of the two changes.

### Emission Spectrum

The emission spectrum of a chemical element or chemical compound is the spectrum of frequencies of electromagnetic radiation emitted by the element's atoms or the compound's molecules when they are returned to a lower energy state. The emission spectrum of each element is unique, thus spectroscopy can be used to identify the various elements in matter of unknown composition. Similarly, the emission spectra of molecules can be used in chemical analysis of substances.

Emission is a process by which a higher energy quantum mechanical state of a particle becomes converted to a lower one through the emission of a photon, resulting in the production of light. The frequency of light emitted is a function of the energy of the transition. The energy states of the transitions can lead to emissions over a very large range of frequencies. For example: the coupling of electronic states in atoms and molecules produces visible light (a phenomenon called fluorescence or phosphorescence); nuclear shell transitions can emit high energy gamma rays; nuclear spin transitions emit low energy radio waves. Precise measurements at many wavelengths allow the identification of a substance via emission spectroscopy.

### Molecules, Charge and Chemical Reactions

A molecule is an electrically neutral group of two or more atoms held together by covalent chemical bonds. Molecules are distinguished from ions by their lack of electrical charge, however, in quantum physics, organic chemistry, and biochemistry, the term molecule is also applied to polyatomic ions. A molecule may consist of atoms of a single chemical element, as with oxygen (O2), or of different elements, as with water (H2O). Molecules as components of matter are common in organic substances and are widely discussed in the field of biochemistry. In molecular sciences, a molecule consists of a stable system (bound state) comprising two or more atoms, polyatomic ions may be thought of as electrically charged molecules. The term unstable molecule is used for very reactive species, i.e., short-lived assemblies (resonances) of electrons and nuclei, such as radicals, molecular ions, Rydberg molecules, transition states, van der Waals complexes, or systems of colliding atoms as in Bose-Einstein condensate.

Ions are atoms or molecules in which the total number of electrons is not equal to the total number of protons, giving them a net positive or negative electrical charge. An anion (−) is an ion with more electrons than protons, giving it a net negative charge. A cation (+) is an ion with fewer electrons than protons, giving it a positive charge. Since the charge on a proton is equal in magnitude to the charge on an electron, the net charge on an ion is equal to the number of protons in the ion minus the number of electrons.

We can illustrate this electrical force phenomena if we take two materials, for example, which are made of atoms, and subject them to an activating force (i.e. water, heat, chemical compound, etc.) and cause the release of the <<activation energy>>, the energy required for a chemical reaction, or in biological systems the <<action potential>> which are potentials generated by voltage-gated ion channels embedded in a cell's plasma membrane. The activating force begins a process whereby, on an atomic level, the transfer of electrical charges between the substances ensues. It is commonly known that electrical charges either attract or repulse among themselves depending on them being positive or negative. Once this process is activated and sustained, the flow of energy is moved from one substance to another. When a sufficient amount of energy is displaced (i.e. electrons or protons), we have a transformation of matter: this is what is called a chemical reaction. The wave-like effects of these transformations in complex systems, and in turn their harmonic frequency components may spread across multiple ranges of the electromagnetic spectrum.

### Living Systems

Life is a characteristic that distinguishes objects that have signaling and self-sustaining processes from those that do not, either because such functions have ceased (death), or else because they lack such functions and are classified as inanimate. Defining life is difficult because life is a process, not a pure substance.

Any contiguous living system is called an organism. These animate entities undergo metabolism, maintain homeostasis, possess a capacity to grow, respond to stimuli, reproduce and, through natural selection, adapt to their environment in successive generations. More complex living organisms can communicate through various means.

Biological definitions of life are generally based upon chemical systems. From the perspective of biophysics, living processes can be viewed as a delay of the spontaneous diffusion or dispersion of the internal energy of biological molecules towards more potential microstates. Living systems are a member of the class of phenomena that are open or continuous and able to decrease their internal entropy at the expense of substances or free energy taken in from the environment and subsequently rejected in a degraded form. It can also be stated that living beings are thermodynamic systems that have an organized molecular structure. Hence, life is a self-sustained chemical system (matter) that can reproduce itself and evolve as survival dictates.

It is thought that the process by which atoms and molecules are organized in living systems involves some sort of electrical or force phenomena that is linked with this process.

All biological systems and living organisms in turn, rely on a specific manner of physical organization of essentially inert or non-living material. The difference between <<living>> systems and <<non-living>> systems has to do with the specific spatial and temporal organization of essentially inanimate atoms and molecules that are the building blocks of biological matter. In biological systems, we generally find the presence of macromolecules whose size and complexity are many orders of magnitude larger than the molecules of inanimate matter.

While it has been scientifically established that all biological systems contain DNA and RNA macro-molecules, at the same time, it cannot be affirmed that the source of life is found in this integrant. Even in the most advanced genetic laboratories, rather than being able to make living matter from the basic inanimate constituents, scientists are required to work with biological material which is already alive.

The fundamental underlying process by which the atoms and molecules are organized in biological systems is of yet largely unknown. In other words, it appears impossible to determine the fundamental mechanisms related to the organization of biological systems when applying standard concepts in physics, chemistry and biology, as life is not a thing but a process.

### Organization and Biological Matter

An organism is any contiguous living system (such as animal, fungus, micro-organism, or plant). In at least some form, all types of organisms are capable of response to stimuli, reproduction, growth and development, and maintenance of homeostasis as a stable whole. An organism may either be unicellular (containing a single cell) or multicellular (containing many cells). The scientific classification in biology considers organisms synonymous with life on Earth. The word organism may broadly be defined as an assembly of molecules functioning as a more or less stable whole that exhibits the properties of life.

Biological matter is able to not only generate energy and preserve energy but also to build upon it. A biological system is working largely on inert un-animated matter, is exchanging electrons and protons, transforming them and creating complex molecular structures that allow the organism to survive, thrive and reproduce. In a cell, for example, which is made up of many molecules that are carefully combined in complex structures, there is a continual exchange of information. There is an exchange of not only random electrical charges but also of electrical charges in the form of information. This process, the aspect of information, has only recently become the object of studies in biological systems. As of yet, the publications that speak about this process mostly adopt a theoretical approach and discussion, however there is no practical presentation of this process.

### The Role of Water

In all biological systems, water plays an important role in the organization of molecules and macromolecules as a great majority of them are bound with water. In chemistry water is described with the formula H2O. Water is a bipolar molecule containing opposing charges. As a result, biological systems exhibit a constant electrical dynamic due to the push and pull of positive and negative charges that are part of not only local biochemical and biological processes but also variations in the environment of the organism.

In a discrete water molecule, there are two hydrogen atoms and one oxygen atom connected by covalent bods. Two or more molecules of water can form a hydrogen bond between them because the oxygen of one water molecule has two lone pairs of electrons, each of which can form a hydrogen bond with another water molecule.

A hydrogen bond is the attractive interaction of a hydrogen atom with an electronegative atom, such as nitrogen, oxygen or fluorine, that comes from another molecule or chemical group. The hydrogen has a polar bonding to another electronegative atom to create the bond. These bonds can occur between molecules (inter-molecularly), or within different parts of a single molecule (intra-molecularly). The hydrogen bond (5 to 30 kJ/mole) is stronger than a van der Waals interaction, but weaker than covalent or ionic bonds. This type of bond occurs in both inorganic molecules such as water and organic molecules like DNA.

The hydrogen bond is often described as an electrostatic dipole-dipole interaction. However, it also has some features of covalent bonding: it is directional and strong, produces inter-atomic distances shorter than sum of van der Waals radii, and usually involves a limited number of interaction partners, which can be interpreted as a type of valence. These covalent features are more substantial when acceptors bind hydrogen from more electronegative donors.

The length of hydrogen bonds depends on bond strength, temperature, and pressure. The bond strength itself is dependent on temperature, pressure, bond angle, and environment (usually characterized by local dielectric constant). The typical length of a hydrogen bond in water is 197 pm. The ideal bond angle depends on the nature of the hydrogen bond donor. Where the bond strengths are more equivalent, the atoms of two interacting water molecules are partitioned into two polyatomic ions of opposite charge.

Water is unique because its oxygen atom has two lone pairs and two hydrogen atoms, meaning that the total number of bonds of a water molecule is up to four. The exact number of hydrogen bonds formed by a molecule of liquid water fluctuates with time and depends on the temperature. Because water forms hydrogen bonds with the donors and acceptors on solutes dissolved within it, it inhibits the formation of hydrogen bonds between molecules of those solutes or the formation of intra-molecular hydrogen bonds within those solutes through competition for their donors and acceptors. Consequently, hydrogen bonds between or within solute molecules dissolved in water are almost always unfavorable relative to hydrogen bonds between water and the donors and acceptors for hydrogen bonds on those solutes. So at any point in time the molecules of water are in a constant state of transferring energy or receiving energy. These characteristics are a crucial part of the uniqueness of water.

FIG. 0.2. Example of the structural effects of water that is exposed to sound vibrations.

### General Features of Waves

A single, all-encompassing definition for the term wave is not straightforward. A vibration can be defined as a back-and-forth motion around a reference value. However, a vibration is not necessarily a wave. An attempt to define the necessary and sufficient characteristics that qualify a phenomenon to be called a wave remains unclear.

The term wave is often intuitively understood as referring to a transport of spatial disturbances that are generally not accompanied by a motion of the medium occupying this space as a whole. In a wave, the energy of a vibration is moving away from the source in the form of a disturbance within the surrounding medium. However, this notion is problematic for a standing wave (for example, a wave on a string), where energy is moving in both directions equally, or for electromagnetic/light waves in a vacuum, where the concept of medium does not apply and the inherent interaction of its component is the main reason of its motion and broadcasting. There are water waves on the ocean surface; light waves emitted by the Sun; microwaves used in microwave ovens; radio waves broadcast by radio stations; and sound waves generated by radio receivers, telephone handsets and living creatures (as voices).

It may appear that the description of waves is closely related to their physical origin for each specific instance of a wave process. For example, acoustics is distinguished from optics in that sound waves are related to a mechanical rather than an electromagnetic wave transfer caused by vibration. Concepts such as mass, momentum, inertia, or elasticity, become therefore crucial in describing acoustic (as distinct from optic) wave processes. This difference in origin introduces certain wave characteristics particular to the properties of the medium involved. For example, in the case of air: vortices, radiation pressure, shock waves etc.; in the case of solids: Rayleigh waves, dispersion etc.; and so on.

Other properties which are usually described in an origin-specific manner, may be generalized to all waves. For such reasons, wave theory represents a particular branch of physics that is concerned with the properties of wave processes independently from their physical origin. For example, based on the mechanical origin of acoustic waves, a moving disturbance in space—time can exist if and only if the medium involved is neither infinitely stiff nor infinitely pliable. If all the parts making up a medium were rigidly bound, then they would all vibrate as one, with no delay in the transmission of the vibration and therefore no wave motion. This is impossible because it would violate general relativity. On the other hand, if all the parts were independent, then there would not be any transmission of the vibration and again, no wave motion. Although the above statements are meaningless in the case of waves that do not require a medium, they reveal a characteristic that is relevant to all waves regardless of origin: within a wave, the phase of a vibration (that is, its position within the vibration cycle) is different for adjacent points in space because the vibration reaches these points at different times.

Similarly, wave processes revealed from the study of waves other than sound waves can be significant to the understanding of sound phenomena. A relevant example is Thomas Young's principle of interference (Young, 1802, in Hunt 1992, p. 132). This principle was first introduced in Young's study of light and, within some specific contexts (for example, scattering of sound by sound), is still a researched area in the study of sound.

Waveform means the shape and form of a signal such as a wave moving in a physical medium or an abstract representation. In many cases the medium through which the wave propagates does not permit a direct visual image of the form. In these cases, the term Waveform' refers to the shape of a graph of the varying quantity against an axis of time or distance. By extension, the term Waveform' also describes the shape of the visual graph of any varying quantity over time.

### Harmonics

A harmonic of a wave is a component frequency of the signal that is an integer multiple of the fundamental frequency. Complex waveforms with a base vibration frequency contain a series of harmonics and sub-harmonics. The harmonics of a signal as defined as related vibrations that are integer multiples of the fundamental oscillation. Theoretically, the harmonic series extends to infinity in both the upper frequency range, multiplying the fundamental frequency for the upper partials, and dividing the fundamental frequency for the lower partials which are called sub-harmonics. We can illustrate this as follows for a fundamental frequency of 440 Hz:

Upper Harmonics (in Hz): 880, 1320, 1760, 2200, etc.

Fundamental Frequency: 440 Hz

Lower Harmonics (sub-harmonics): 220, 110, 55, 27.5, etc.

The fundamental frequency is the reciprocal of the period of a periodic function.

It is thought that any phenomena occurring at one band of the electromagnetic spectrum may have influences across multiple other ranges (i.e. the heating effects on cells via electromagnetic radiation; the creation of resonant low frequency standing waves in acoustic environments caused by sound vibrations).

Any complex waveform an be described as a vibration composed of a series of simple periodic waves (sine waves) each with its own frequency, amplitude, and phase. A harmonic (or a harmonic partial) is any of a set of vibrations that are whole number multiples of a common fundamental frequency and is any of the sine wave components by which a complex waveform is described. Inharmonicity is a measure of the deviation of a partial from the closest ideal harmonic.

A harmonic of a wave is a frequency component of the signal that is an integer multiple of the fundamental frequency. For example, if the fundamental frequency is f, the harmonics have frequencies 2f, 3f, 4f, etc. The harmonics have the property that they are all periodic at the fundamental frequency; therefore the sum of harmonics is also periodic at that frequency. Harmonic frequencies are equally spaced by the width of the fundamental frequency and can be found by repeatedly adding that frequency. For example, if the fundamental frequency is 25 Hz, the frequencies of the harmonics are: 50 Hz, 75 Hz, 100 Hz etc.

The Fourier series describes the decomposition of periodic waveforms, such that any periodic waveform can be formed by the sum of a (possibly infinite) set of fundamental and harmonic components. Finite-energy and non-periodic waveforms can also be analyzed into sinusoids by the Fourier transform.

Waveforms that contain a regular and ordered harmonic content are said to be coherent, while waveforms with an unordered harmonic content are said to be incoherent or chaotic.

The harmonic content of complex waveforms is equivalent to information.

### Standing Waves

Two waves with the same frequency, wavelength and amplitude traveling in opposite directions will interfere and produce a standing wave. A standing wave, also known as a stationary wave, is a wave that remains in a constant position. This phenomenon can occur when the medium is moving in the opposite direction to the wave, or it can arise in a stationary medium as a result of interference between two waves traveling in opposite directions. In the second case, waves of equal amplitude traveling in opposing directions, produce no net propagation of energy. In a resonator, standing waves occur during the phenomenon known as resonance. The frequencies of these waves all are multiples of the fundamental, and are called harmonics or overtones. The distance between two conjugative nodes or anti-nodes is λ/2.

Standing waves occur in two and three-dimensional resonators. On two dimensional membranes, the nodes become nodal lines that separate regions vibrating with opposite phase. These nodal line patterns are called Chladni figures. Three-dimensional resonators produce nodal surfaces.

In physical media waves traveling along the medium will reflect back when they reach the end or boundary of the medium where, at various multiples of a natural frequency, standing waves called harmonics are produced. Nodes occur at fixed ends and antinodes at open ends of the medium. The density of the medium will affect the frequency at which harmonics are produced. The greater the density of the medium, the lower the frequency needs to be to produce a standing wave of the same harmonic.

A standing wave in a transmission line is a wave in which the distribution of current, voltage, or field strength is formed by the superposition of two waves of the same frequency propagating in opposite directions. This results in a series of nodes having zero displacement, and anti-nodes having maximum displacement, at fixed points along the transmission line.

Standing waves are also observed in optical media where the transmitted and reflected waves superpose, and form a standing-wave pattern.

Standing waves can be mechanically induced into solid medium using resonance. This will form regular patterns containing nodes and antinodes that appear to be stationary and can be used to track changes in frequency or phase of the resonance of the medium.

### Resonance

Resonance is the tendency of a system to oscillate at greater amplitude at some frequencies than at others, these are known as the system's resonant frequencies. At these frequencies, even small periodic driving forces can produce large amplitude oscillations, because the system stores vibrational energy. Resonance occurs when a system is able to store and easily transfer energy between two or more different storage modes such as kinetic energy and potential energy.

Most systems have multiple, distinct, resonant frequencies and resonance phenomena occur with all types of vibrations or waves which include: mechanical resonance, acoustic resonance, electromagnetic resonance, nuclear magnetic resonance (NMR), electron spin resonance (ESR) and resonance of quantum wave functions. Resonant systems can be used to generate vibrations at a specific frequency, or to select specific components from a complex vibration containing many frequencies.

The resonant response of a system, especially for frequencies that are distant from the natural resonant frequency, depends on the details of the physical system, and is usually not exactly symmetric about the resonant frequency.

In many physical situations involving resonant systems the resonant intensity is defined as the square of the amplitude of the oscillations. The resonant line width is a parameter dependent on the damping of the oscillator. Heavily damped oscillators tend to have broad line widths, and respond to a wider range of driving frequencies around the resonant frequency. The line width is inversely proportional to the Q factor, which is a measure of the sharpness of the resonance.

A physical system can have as many resonant frequencies as it has degrees of freedom; each degree of freedom can vibrate as a harmonic oscillator. As the number of coupled harmonic oscillations grows, the time for the transfer energy from one to the next becomes significant. The vibrations in these systems travel through coupled harmonic oscillations in the form of waves, from one resonant node to the next.

Mechanical resonance is the tendency of a mechanical system to absorb more energy when the frequency of its oscillations matches the system's natural frequency of vibration than it does at other frequencies. Overstimulation at resonant frequencies may cause violent swaying motions and even catastrophic failure in physical systems.

Resonance occurs widely in nature, and is exploited in many man-made devices such as oscillators, transmitters, machines, lasers, musical instruments, etc. Many sounds we hear, such as when objects of metal, glass, or wood are struck, are caused by brief resonant vibrations in the object. Light and other short wavelength electromagnetic radiation is produced by resonance on an atomic scale, such as electrons in atoms. Resonance occurs in electric circuits when the transfer function is at a maximum, in other words, when the impedance of the circuit is at a minimum in a series circuit or at a maximum in a parallel circuit. Orbital resonances occur when orbiting celestial bodies exert regular, periodic gravitational influences on each other due to their orbital periods being related by ratios of small integers.

Nuclear magnetic resonance (NMR) is a physical resonance phenomenon involving the specific quantum mechanical magnetic properties of atomic nuclei in the presence of externally applied magnetic fields. A key feature of NMR is that the resonant frequency of a particular substance is directly proportional to the strength of the applied magnetic field.

In quantum mechanics and quantum field theory, resonances may appear under similar circumstances as in classical physics, however, they can also be thought of as unstable particles.

### BACKGROUND TO THE INVENTION

A common and universal problem that is related to food quality is the loss of vitality between the time that a fruit or vegetable is harvested and the time that it is consumed. Many fresh agricultural products are transported over long distances, sometimes many thousands of kilometers, before arriving to market. In addition, many fresh food products are harvested while still green and they are stored in refrigerated containers for extended periods of time. Oftentimes they are treated with an artificial ripening agent such as ethylene before being sold to the public. Consumers equally have concerns with respect to food quality, as unripened fruits are generally inedible as they lack flavor, texture and vitality, while ripened fruits must be consumed quickly otherwise they risk spoilage.

Through the longstanding research in the field of bioharmonic signals, it has been discovered that qualitative and quantitative measurements on fresh food products could be obtained, and that the structure of the bioharmonic signal could be used to objectively identify signatures related to freshness, ripeness, sugar content and vitality. In addition, the inventor has discovered that through modulating the electromagnetic bioharmonic fields of fresh fruits and vegetables, it is possible to affect the preservation time, control ripeness and manage vitality.

### STATE OF THE ART

The techniques used today to preserve fresh food products during transport and storage rely on refrigeration and the harvesting of unripe fruits that are then artificially ripened via the use of ethylene. While theses practices may make fruits available yearlong, they oftentimes sacrifice food quality that can be measured objectively in terms of freshness, color taste, odor and vitality. The availability of large scale, non-chemical methods of food preservation are limited, while the subject of vitality is practically ignored.

The novel invention that is presented and described here, does offer a unique, environmentally conscious, effective and inexpensive means to preserve food product quality while enhancing vitality.

### SUMMARY OF THE INVENTION

In a first aspect the invention provides an inductive disk or plate containing an etched, printed or glued conductive material in the form of a coil having a specific geometric shape, arranged such that the natural flow of electrically charged particles, such as electrons or protons, that are plentiful in biological systems, activate the inductive properties of the inductive disk or antenna, and thus generate an induced electromagnetic signal in the coil.

In a preferred embodiment the inductive disk or plate further comprises a variable resistor and variable capacitor arranged such to creating an LRC circuit, allowing the system to oscillate at a specific frequency.

In a second aspect the invention provides a flat electrically neutral surface upon which a conductive material is placed, etched, printed or attached with an adhesive, the conductive material being arranged in a manner where the individual wires or traces are arranged in parallel and follow a similar path towards the center of the electrically neutral surface having a smaller diameter with each turn or winding.

In a further preferred embodiment the conductive material, on the electrically neutral surface, is arranged according to a specific geometric shape.

In a further preferred embodiment the configuration of the windings of the conductive material on the flat electrically neutral surface function as an inductor.

In a further preferred embodiment the fixed electrically neutral surface is an electronic circuit board, glass, wood, ceramic or composite material, or a flexible electrically neutral surface such as a plastic sheet, rubber pad, cloth or composite material.

In a third aspect the invention provides the use of the inductive disk or plate as an active antenna capable of transmitting and receiving wavelengths related to the size of the coil windings if a electronic oscillator is attached to the windings.

In a fourth aspect the invention provides the use of the inductive disk or plate as a fixed or variable resonator having inductive properties related to the size of the coil windings and values of the resistor and capacitor.

In a fifth aspect the invention provides the use of the inductive disk or plate as a fixed or variable resonator having inductive properties related to the size of the coil windings and values of the resistor and capacitor that is electrically activated by the free electrical charges of fresh fruits and vegetables that are placed in contact with the device.

In a sixth aspect the invention provides the use of the inductive disk or plate as a fixed or variable resonator having inductive properties related to the size of the coil windings and values of the resistor and capacitor that is electrically activated by the use of an external signal oscillator producing a signal at the resonant wavelength of the coil windings.

In a seventh aspect the invention provides the use of the inductive disk or plate as a fixed or variable resonator having inductive properties related to the size of the coil windings and values of the resistor and capacitor that is mounted inside a shipping or storage container for the transport or storage of fresh fruits and vegetables.

In an eighth aspect the invention provides the use of the inductive disk or plate as a fixed or variable resonator having inductive properties related to the size of the coil windings and values of the resistor and capacitor that is printed on packaging materials such as paper, plastic or derivatives, that are in contact with fresh food products.

In a ninth aspect the invention provides the use of the inductive disk or plate as a fixed or variable resonator having inductive properties related to the size of the coil windings and values of the resistor and capacitor that is imbedded into performance and sports related clothing, footwear and equipment.

In a tenth aspect the invention provides the use of the inductive disk or plate as a fixed or variable resonator having inductive properties related to the size of the coil windings and values of the resistor and capacitor that is imbedded into therapeutic products such as patches, prosthetic devices, implants and equipment.

In an eleventh aspect the invention provides the use of the inductive disk or plate as a fixed or variable resonator having inductive properties related to the size of the coil windings and values of the resistor and capacitor that is imbedded into professional and consumer kitchen products such as storage bins, containers, packaging, cooking pots, frying pans, baking dishes, woks, glassware, and utensils.

### BRIEF DESCRIPTION OF THE FIGURES

The invention will be discussed below in a more detailed way with examples illustrated by the following figures:

FIG. 0.1 Electromagnetic Spectrum.

FIG. 0.2 Example of the structural effects of water that is exposed to sound vibrations.

FIG. 1 Star shaped antenna on a disk shaped substrate.

FIG. 2. Geometric antenna forms

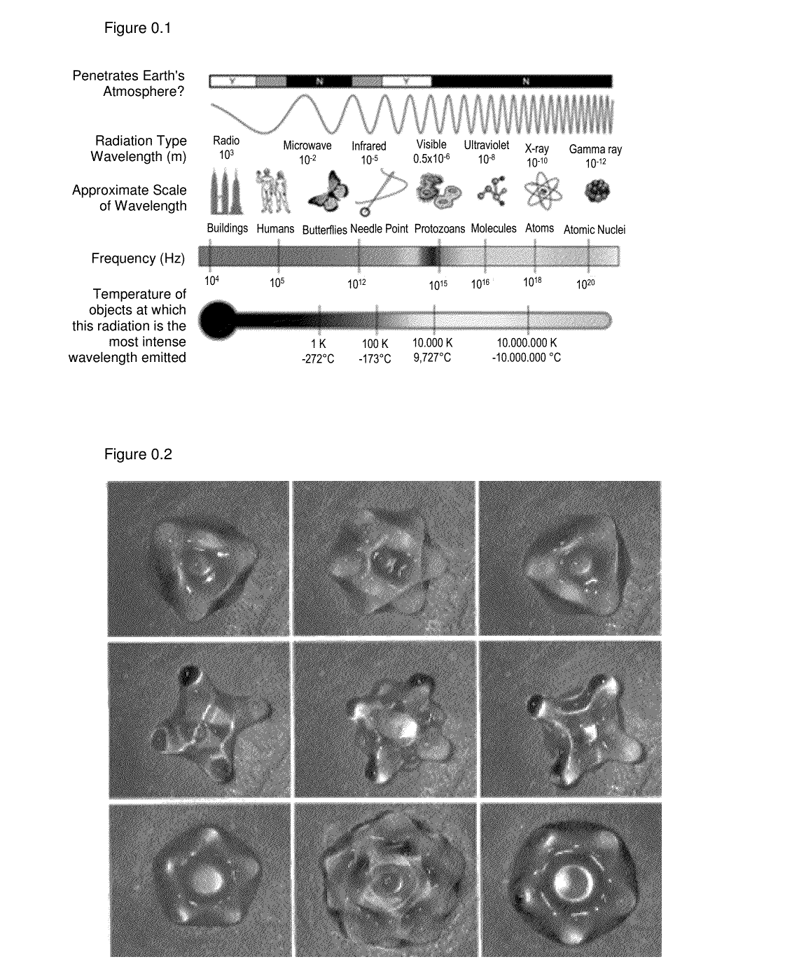

Figure T1 Effects of a vortex inductor on a glass of water. Experiment set up.

Figure T2. Effects of a vortex inductor on a glass of water. Surface Spectrum.

Figure T3. Effects of a vortex inductor on a glass of water. Spectral response and spectral phase.

Figure T4. Effects of a vortex inductor on a glass of water. Spectral response and spectral phase.

Figure T5. Effects of a vortex inductor on a fresh clementine. Experiment set-up.

Figure T6. Effects of a vortex inductor on a fresh clementine. Surface Spectrum.

Figure T6.1 Effects of vortex Inductor on a clementine. Spectral response and spectral amplitude.

Figure T7. Effects of a vortex inductor on a fresh clementine. Spectral response and spectral amplitude.

Figure T8 Effects of a vortex inductor on a fresh clementine. Spectral response and spectral phase.

Figure T9 Effects of a vortex inductor on a fresh mangoes. Treated and untreated samples after 15 days of refrigeration at 5 degrees celsius.

Figure T10. Effects of a vortex inductor on a fresh tomatoes. Treated and untreated samples after 15 days of refrigeration at room temperature.

Figure T11 Effects of a vortex inductor on shredded carrots and prepared fruit salad. Treated and untreated samples after 15 days of refrigeration at 5 degrees celsius.

Figure T12 Effects of a vortex inductor on cut salad and salad greens. Treated and untreated samples after 15 days of refrigeration at 5 degrees celsius.

Figure T12.1 Hexagonally shaped inductive disk.

Figure T12.2 The electric and magnetic field force lines produced by a coil inductor.

Figure T13 The direction of electric current produced by a coil inductor.

Figure T14 The direction of electric current produced by a triangular coil inductor.

Figure T15 The induction of electric current produced by a inductive vortex and a tomato.

Figure T16 An active version of the vortex inductor having a variable resistance and capacitance.

Same reference numbers will be used throughout the figures and the whole description to designate same or similar features

### Treatment Effects of Inductive Disk

### Effect of Inductive Disk on a Glass of Water

### Description of Experiment

The purpose of the experiment is to validate whether the Vortex inductor has an effect on the electrical field characteristics on a sample of tap water in a regular glass. Local tap water was used in the experiment. The water was first placed into a glass container and left for 1 hour in order to allow the effects of the municipal water system pressure and chlorination to stabilize. The water was poured from the glass container into the drinking glass and left to stand for an additional 30 minutes. The water was tested with with the Bioscope Model 1000 device using a 0.01 mm surgical steel electrode. The untreated water was tested in the glass for a period of 30 seconds. The glass was then placed onto the Vortex Inductor and again tested for 30 seconds; the water was left to stand on the Vortex Inductor for 5 minutes and tested again to check for longer term exposure to the effects of the Vortex Inductor.

Figure T1. Effects of a vortex inductor on a glass of water. Experiment set-up.

Figure T2. Effects of a vortex inductor on a glass of water. Surface Spectrum

Figure T3. Effects of a vortex inductor on a glass of water. Spectral response and spectral amplitude.

Figure T4. Effects of a vortex inductor on a glass of water. Spectral response and spectral phase.

Discussion on Treatment of Water with Vortex Inductor

The concept of “dynamisation” can be though of as an electrical phenomenon that is part of a specific biological process that allows matter—in this case water—to be transformed by a biological system. From the observed results, it is evident that the vortex inductor had significantly increased the electrical “information” in the water as can be seen in the increase of electrical coherence in the system in FIG. 3. The vortex inductor had modified the spectral response of the system (FIG. 4) and increased the overall amplitude of the spectral charge (FIG. 5). An increase in charge can be equated to a higher potential during the process of a transformation such as digestion, as all chemical reactions are in fact “electrical” in nature involving the exchange of ions or electrons.

The phase of the system was also modified (FIG. 6) showing that the overall electrical spin had been significantly decreased after a five minute exposure to the effects of the vortex inductor. The spin corresponds to the capacity of a biological system to be transformed, for example more readily digested or in the case of water absorbed by the system.

The vortex inductor can be applied in the treatment of water to increase absorption and transformation in a biological system.

### Effect of Inductive Disk on a Clementine

### Description of Experiment

The purpose of the experiment is to validate whether the Vortex Inductor has an effect on the electrical field characteristics of a fruit sample—a Clementine orange. A store bought (non-bio) Clementine was used in the experiment. The Clementine was tested with with the Bioscope Model 1000 device using a 0.01 mm surgical steel electrode. The Clementine was tested for a period of 30 seconds. The Clementine was then placed onto the Vortex Inductor and again tested for 30 seconds; the Clementine was left to stand on the Vortex Inductor for 5 minutes and tested again to check for longer term exposure to the effects of the Vortex Inductor.

Figure T5. Effects of a vortex inductor on a fresh clementine. Experiment set-up.

Figure T6. Effects of a vortex inductor on a fresh clementine. Surface Spectrum

Figure T7. Effects of a vortex inductor on a fresh clementine. Spectral response and spectral amplitude.

Figure T8. Effects of a vortex inductor on a fresh clementine. Spectral response and spectral phase.

Discussion on Treatment of Water with Vortex Inductor

The concept of “vitality” can be though of as an electrical phenomenon that is part of a specific biological system—in this case a Clementine. From the observed results, it is evident that the vortex inductor had significantly increased the vitality “information” in the fruit as can be seen in the increase of electrical coherence in the system in FIG. 3. The vortex inductor had modified the spectral response of the system (FIG. 4) and increased the overall amplitude of the spectral charge (FIG. 5). An increase in charge can be equated to a higher potential during the process of a transformation such as digestion, as all chemical reactions are in fact “electrical” in nature involving the exchange of ions or electrons.

The phase of the system was also modified (FIG. 6) showing that the overall electrical spin had been significantly decreased after a five minute exposure to the effects of the vortex inductor. The spin corresponds to the capacity of a biological system to be transformed, for example more readily digested.

The vortex inductor can be applied in the treatment of fresh fruits to increase the vitality of the biological system.

### Experiments on Fresh Fruits and Vegetables

Experiments using the vortex inductor ware carried out on a series of fresh fruit and vegetable samples. The purpose of the experiments was to determine whether it would be possible to preserve the freshness of the fruit and vegetables by the introduction of a self induced bioharmonic field.

Figure T9. Effects of a vortex inductor on a fresh mangoes. Treated and untreated samples after 15 days of refrigeration at 5 degrees celsius.

Figure T10. Effects of a vortex inductor on a fresh tomatoes. Treated and untreated samples after 15 days of refrigeration at room temperature.

Figure T11. Effects of a vortex inductor on shredded carrots and prepared fruit salad. Treated and untreated samples after 15 days of refrigeration at 5 degrees celsius.

Figure T12. Effects of a vortex inductor on cut salad and salad greens. Treated and untreated samples after 15 days of refrigeration at 5 degrees celsius.

The experiments carried out on fresh fruit, vegetable and salad samples demonstrate that by stimulation of the bioharmonic field with the vortex inductor did play a role sample quality. While the untreated products showed clear signs of rot and decay, the treated samples, in all cases, did preserve cellular and biological structural coherence and integrity.

### Description of Background Theory and Preferred Embodiments

Figure T12.1 Hexagonally shaped inductive disk.

Figure T12.1 is an illustration of an example vortex antenna according to the invention. A substrate carries a plurality of conducting lanes that can be interconnected by means of their respective ends. The substrate is disc shaped in this example but could in fact have any other shape as needed for the specific circumstances in which the vortex antenna is planned to be used. The constitution of the vortex antenna disc assembly represents the equivalent of a mechanical antenna that is upwards of 30 m long, which thus has the capacity to resonate at extremely low frequencies.

The basic principle behind the vortex antenna is very simple: it functions as a passive inductor that is powered by the free electric charges, electrons and protons, that are naturally occurring in biological matter. The vortex antenna contains parallel electrical lanes, electrical traces, each one of which induces an electrical current between itself and the biological matter that is being probed, if the vortex antenna is used as part of a signal detection or sensor system.

Figure T12.2 The electric and magnetic field force lines produced by a coil inductor.

Due to the specific geometric nature of the lanes on the substrate, the vortex antenna induces a structured electric field. In addition to the electric current which is flowing through the conductive lanes, electric and magnetic forces are generated by the geometrical layout of the electrical lanes at the same time. The purpose of this layout is to generate the electric and magnetic field in a specific geometry.

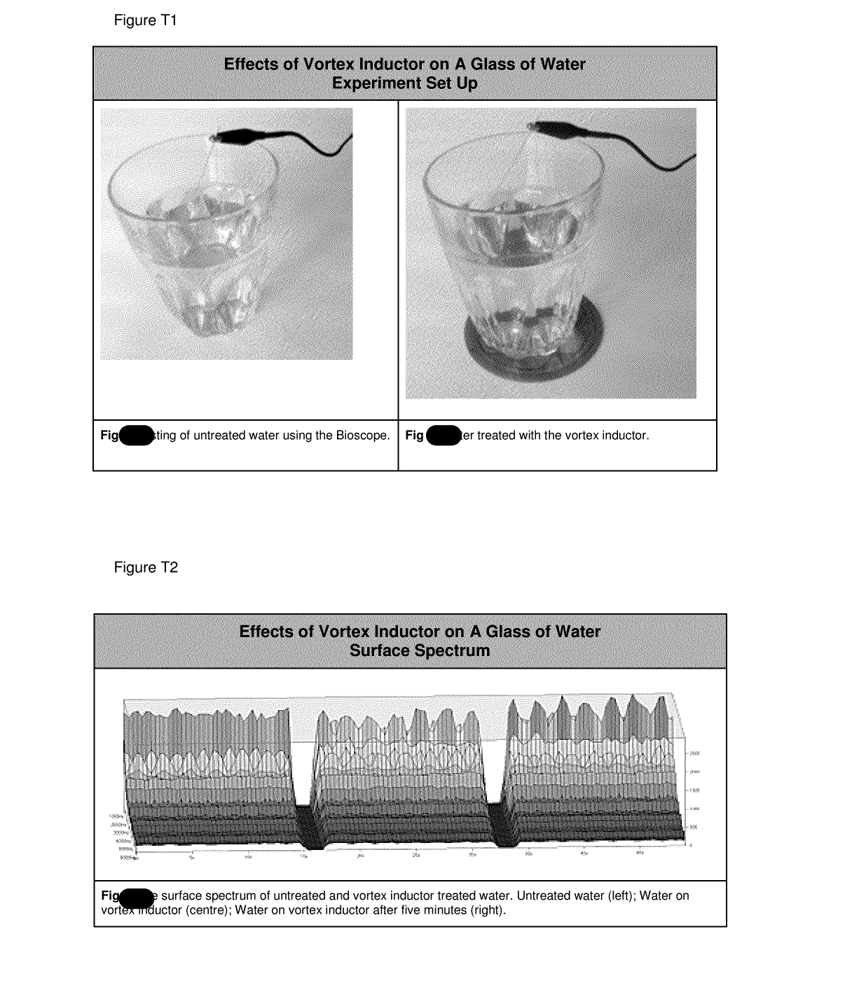

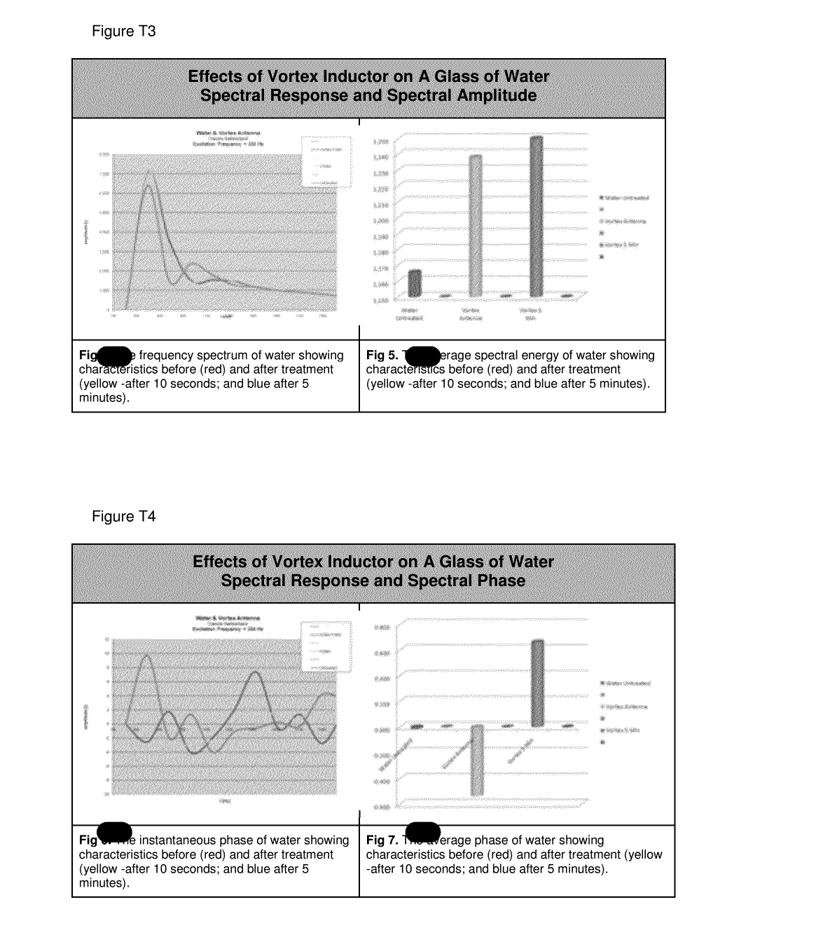

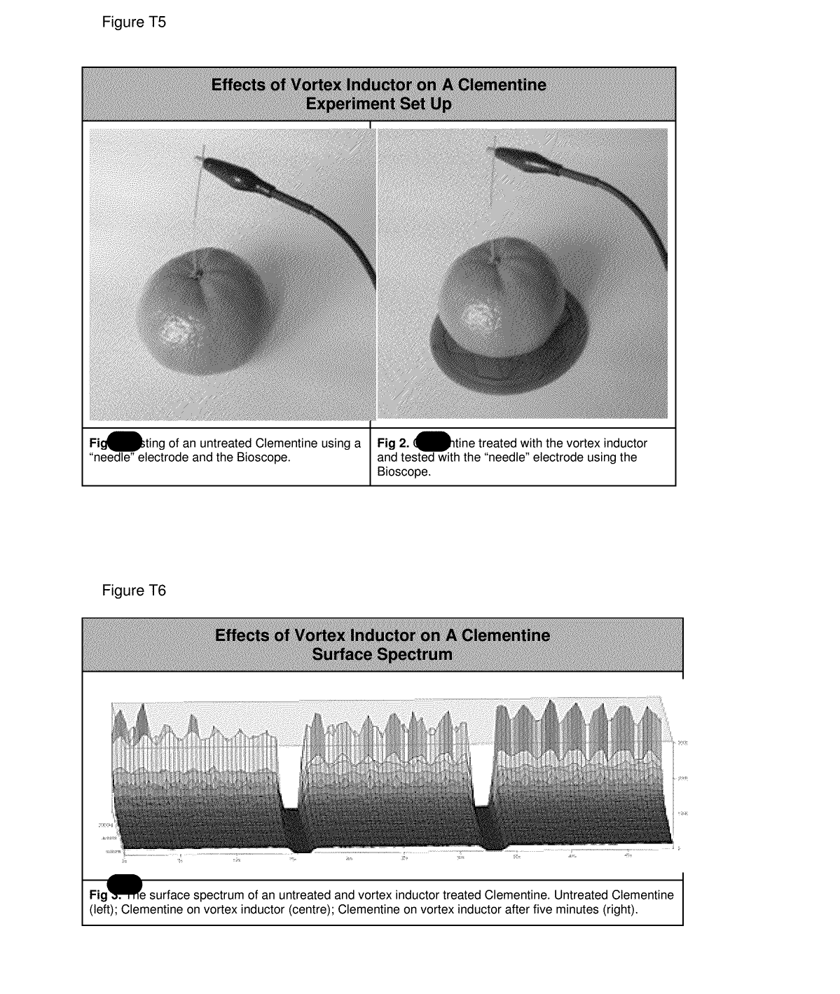

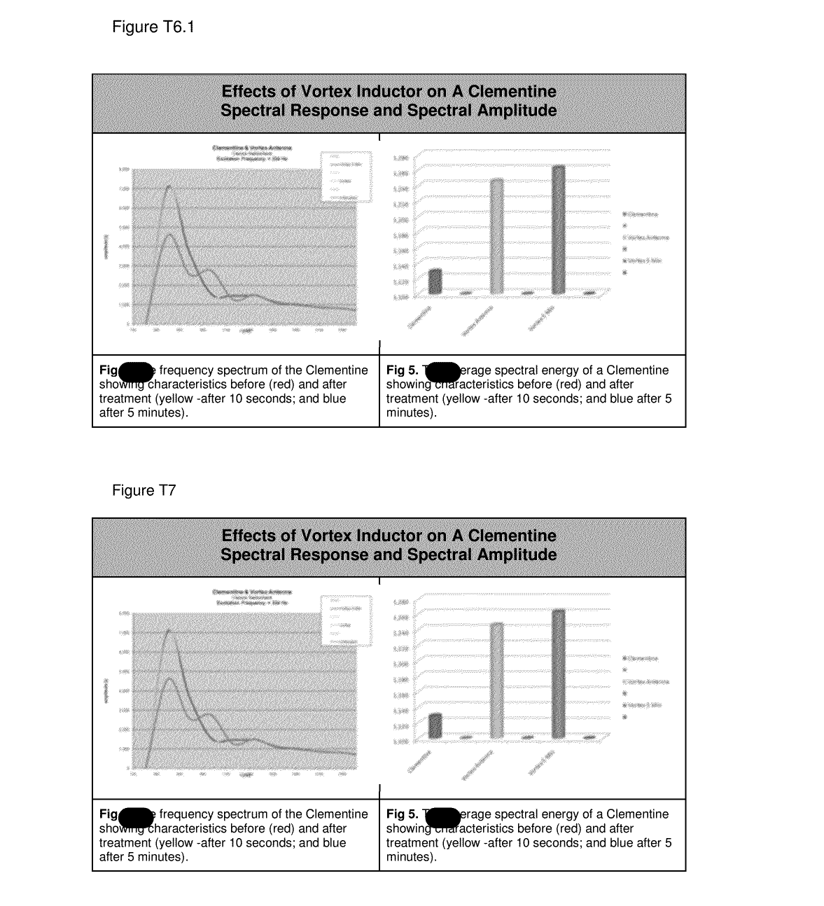

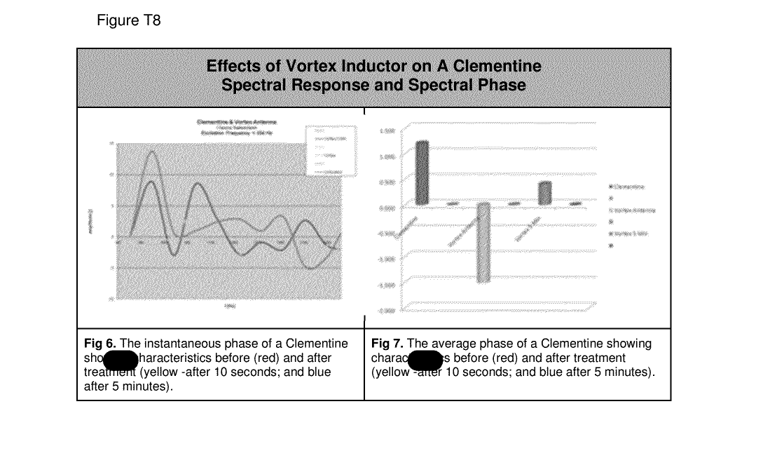

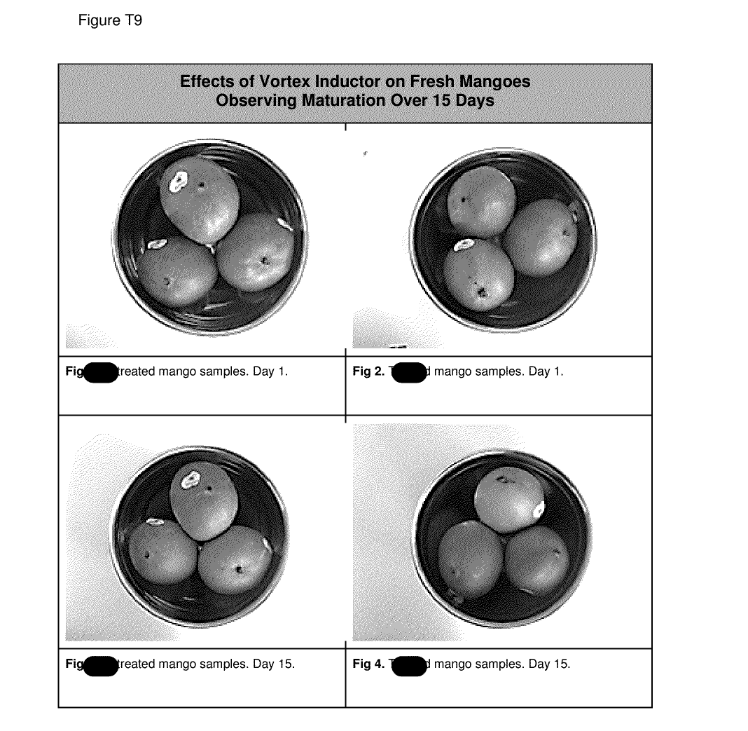

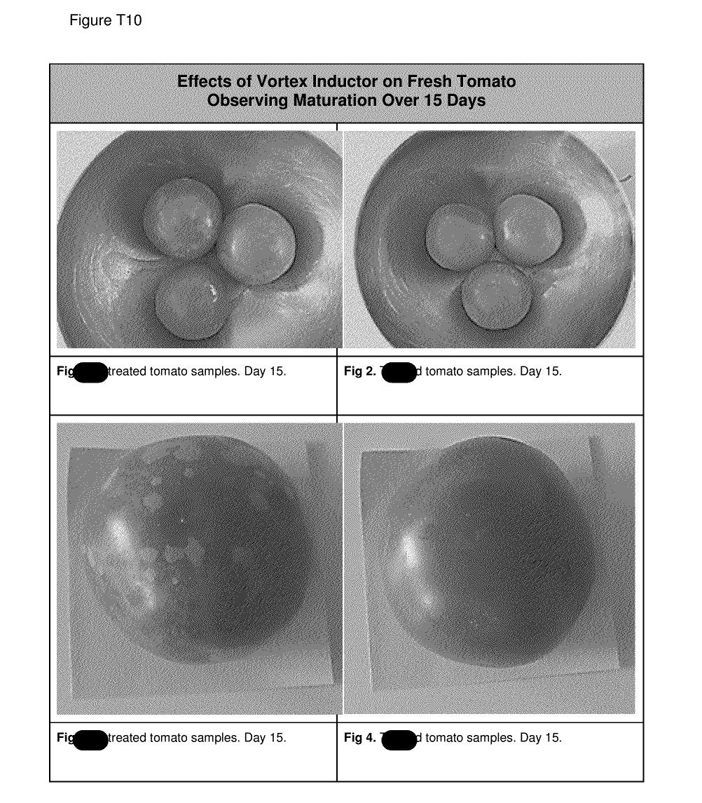

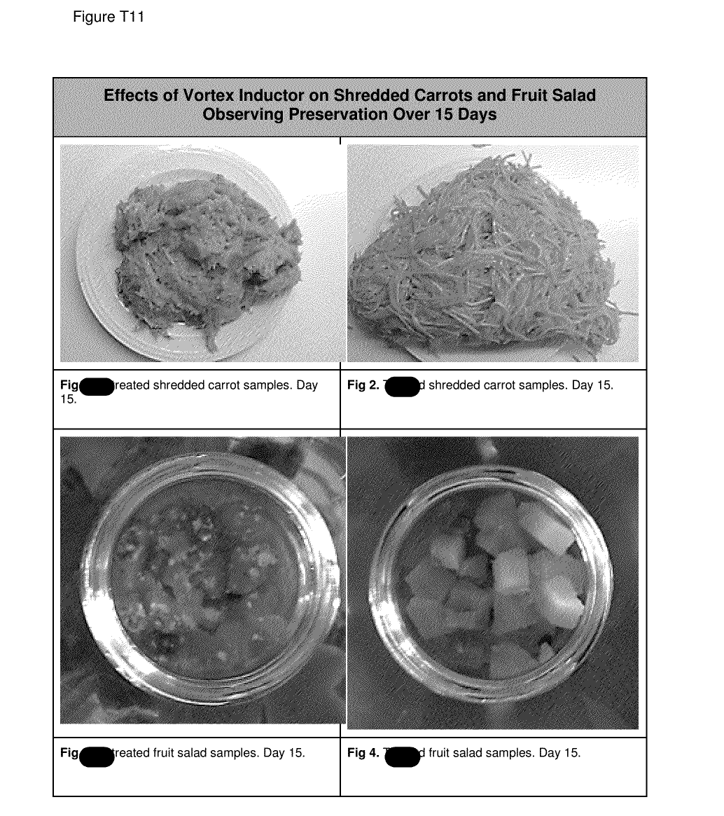

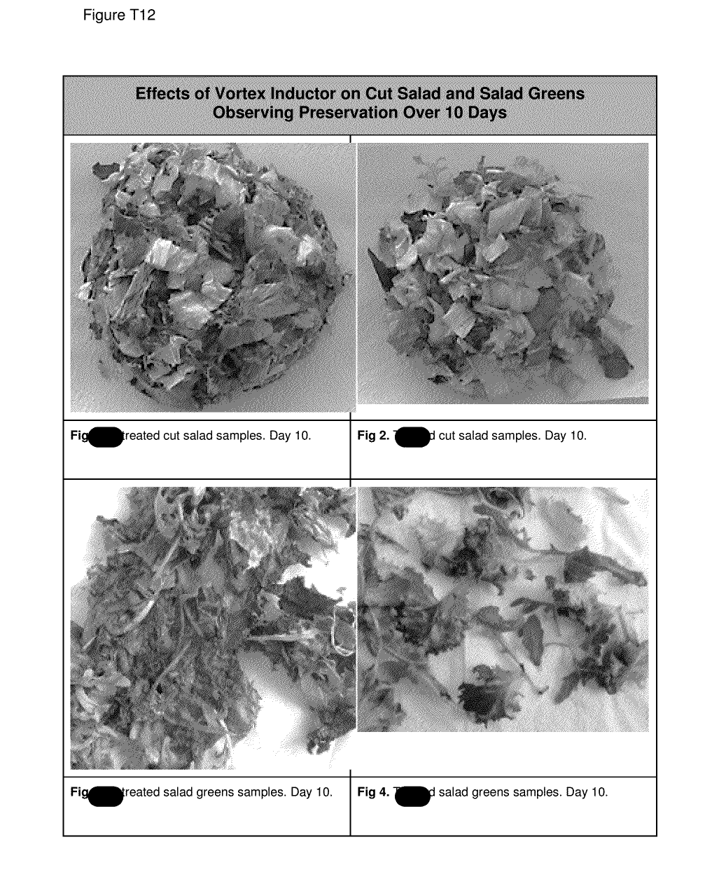

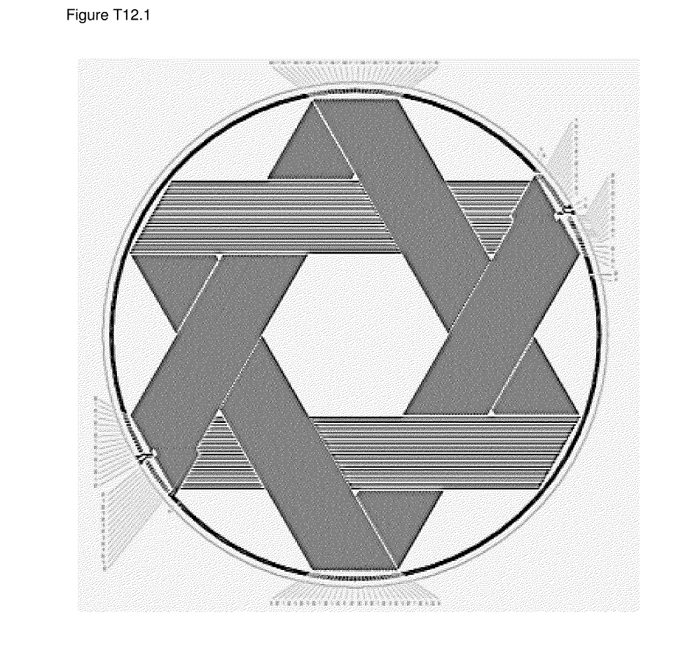

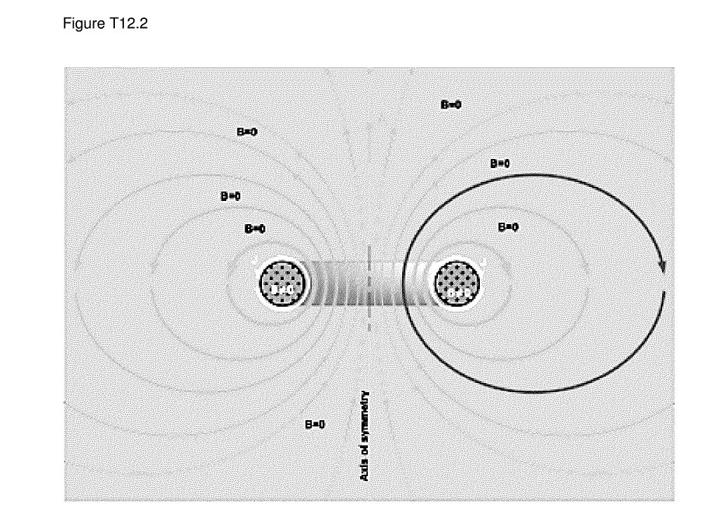

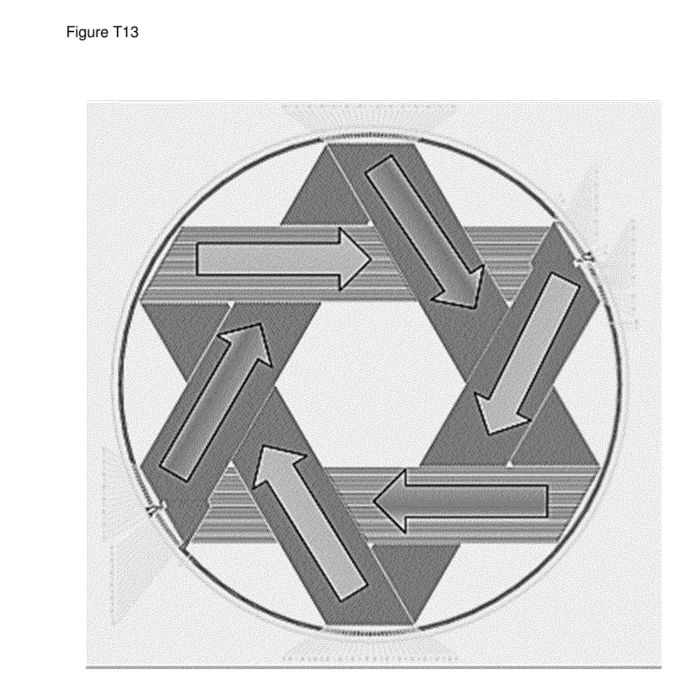

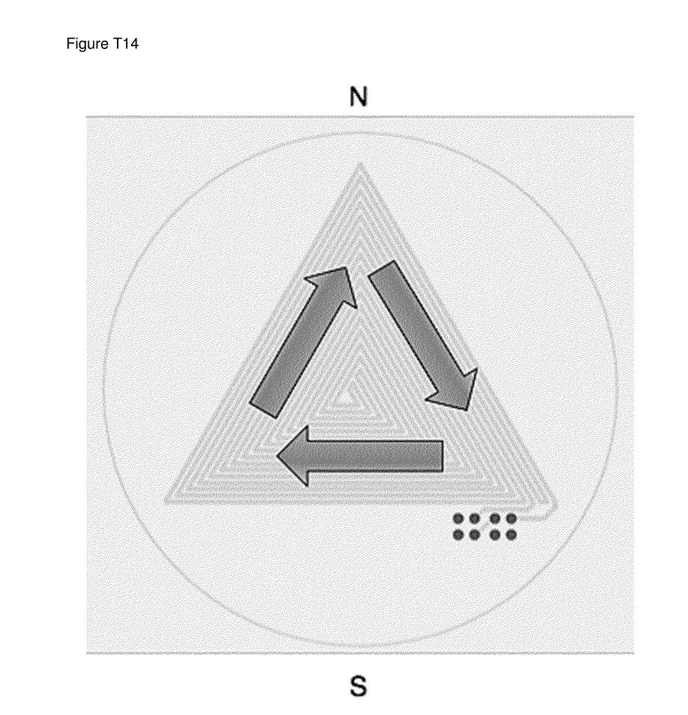

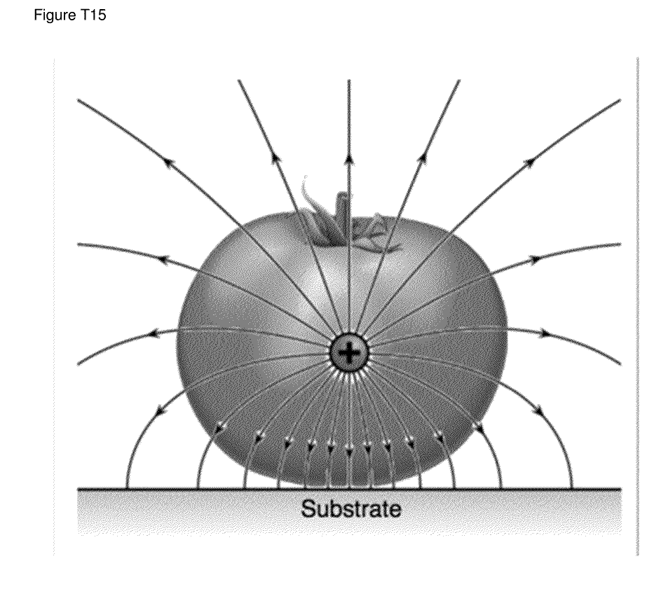

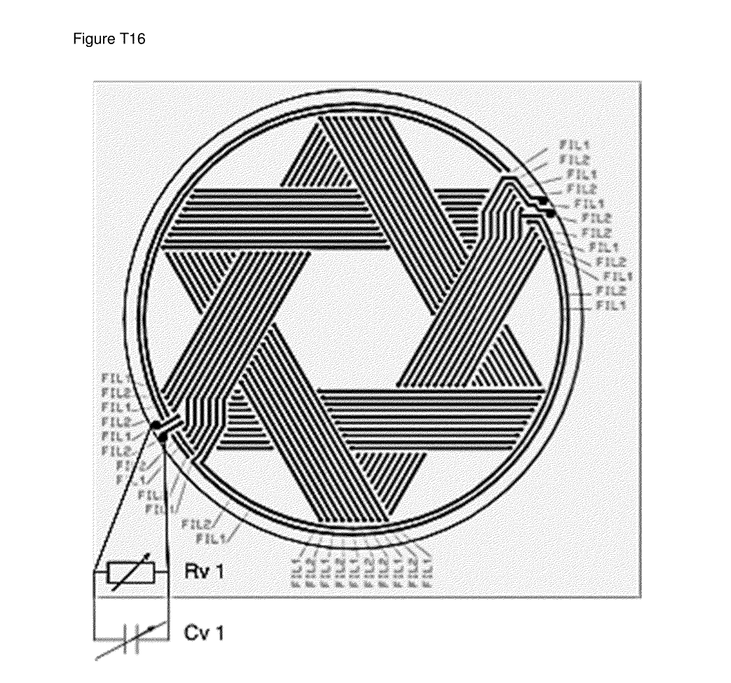

The specific geometry can be applied as we see in FIG. 2

The specific geometry is applied to interact with the fundamental geometry of for example, flowers and plants, or any other biological system. The result is that the resulting force will stimulate the natural structured fields already inherent in these biological systems. One direct use of this inductive force is to preserve the freshness of vegetable. A few example for this are shown in figure (See Above).

The reason why the freshness of biological systems is preserved is that by means of the inventive antenna, we are stimulating the electrical flow in the biological system through induction. Hence simply the fact of having two parallel conductive lanes, or more, is enough to generate electrical current and a magnetic field in the biological system through inductive force.

Figure T13. The direction of electric current produced by a coil inductor.

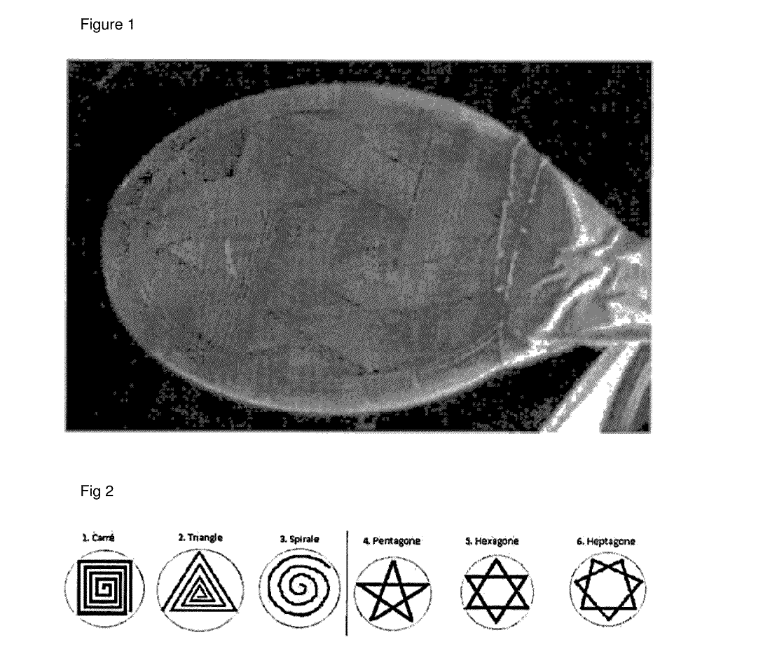

One advantage of the antenna shown in FIG. 1 is that we have a specific geometry, and we can extend the length of the antenna, for example by printing on 2 sides of the circuit board substrate. This way we can achieve a multilayer circuit board, on which where we can have 3 or 4 different antennas, whereby the antenna may or may not be geometrically related. For example, one layer may be a triangle, the other layer a hexagram, and the third layer is a nonagon, i.e. a 9 pointed star.

The geometrical shape reinforces certain harmonics. Looking now at the harmonic structure of the electrical wave we produce, using the layers with triangle, hexagram and nonagon, we stimulate the first, the third, the 6th and the 9th harmonics. Other geometric configurations of the antenna, such as a pentagram, can be used to stimulate the 5th, the 10th, the 15th harmonics. Harmonics are the information that is inherent in a waveform, and that is an important aspect of its applicability for a specific situation.

The basic functionality of the inventive antenna, which is a completely passive device that generates an electrical and magnetic effect, can be extended by for example modulating the generated frequency: this is done for example by adding a simple capacitor or resistor in the circuit of the antenna (not shown in FIG. 1). We then obtain a simple LCR circuit. With an inductor and capacitor—the parallel electrical lanes are the inductor and the capacitor—adding a variable resistor results in being able to generate a determined frequency at which a charge/discharge occurs.

The inventive antenna can be printed on circuit boards of varying sizes, e.g. relatively small ones, from about 1 cm across, to relatively large ones, about 60-70 cm in diameter which should be applicable for example for shipping materials, shipping crates, people that transport fresh vegetables over long distance, this can be placed inside the crate, and the entire shipment in the crate would/can be stimulated to preserve freshness.

In an even further preferred embodiment, the inventive antenna may be printed on flexible film. The inventive antenna can also be printed on flexible sheets and then be applied as a sticker to packaged food, therewith helping to preserve the food. The inventive can also be embedded and printed on flexible material, paper or plastic that is afterwards embedded inside packaging materials, e.g., inside a milk carton or a juice carton. Hence it is possible to have this structure, built directly into the package which would preserve the shelf life of the juice, milk or of your cheese.

The inventive antenna can be applied to people, e.g., applied to different zones on the body. Since the antenna is generating an electrical field, applying it on different zones on the body, it could be used to stimulate the functioning or to release pain in these different zones of the body. Pulsed magnetic therapy, is very well known to relieve pain. The inventive antenna produces a similar effect to that of pulsed magnetic field, electrical field, by introducing this into a configuration of a LRC circuit. We can imagine different sizes of these plates/circuits boards which could be placed on the body, or printed on flexible film that could be used as a patch, for sporting people, for people suffering from chronic diseases, or from chronic pain. The inventive antenna could also be inside the shoe, or placed inside sporting equipment. Technically, it is relatively simple to manufacture the inventive antenna and to use it for the purposes as explained herein above.

Coming back now to the antenna, it has a fixed length which corresponds to the specific wavelength, i.e., this can also be a frequency that is aimed to be received and/or amplified.

As an example, an antenna having 10 m length would be able to capture low frequency wavelengths of 34.3 Hz. The conducting lanes making up the antenna on the substrate may be located on either side of the substrate and even on both sides of the substrate at the same time, whereby perforations may be operated through the substrate to connect conducting lanes between each other. Hence it is easy to obtain a relatively long antenna on a relatively small sized substrate. As an example it is possible to obtain a 30 m long antenna on a substrate of disc shape with 8 cm diameter. A 30 m long antenna is adapted to correspond to the frequency of 11,4 Hz.

If 2 conducting lanes are laid out on the substrate parallel among each other, we will induce electrical current in one of the conducting lanes if a current flows in the other conducting lane in the first place.

This phenomena all on its own will produce electrical current typically in micro amperes, so creating relatively low voltages between the extremities of the conducting lanes. Now because this phenomena is constant, it will produce a specific current and a specific voltage with a constant rate. We can see that this object contains a fixed electrical charge. So it is a naturally charged object. And an example of a naturally charged object would be a crystal. Under the right conditions, a crystal can produce a series of fixed frequencies at extremely high rates.

As opposed to the crystal, the relatively long antenna according to the invention provides a fixed frequency but at an extremely low rate. If we change the orientation of these wires, and we call one of our directions: north. In this particular configuration, we have an electrical field that is flowing east-west and we have a magnetic field which is flowing north-south. In this configuration, we have an electrical field flowing north-south and magnetic field flowing east-west. Here is a very simple example using two wires.

An example of a more complex structure, in this case a triangle, is shown in figure T14.

Figure T14. The direction of electric current produced by a triangular vortex inductor.

In the triangle of figure xx the top point of the triangle is labeled north. We see that on the one side, we have an electrical flow going north west, on the other side we have an electrical flow going north-east and at the base we have an electrical flow going eastwest. Looking at the triangle in 3 dimensions, we know now that the magnetic current draws this and I'll try to represent this, magnetic current is 90 degrees, we can imagine this in 3D, of surface, of these positions. In space, if we take a sign period now, so or triangle is actually on the board, we will see that we have a magnetic force, that look something like this.

Let us consider an example of biological system to be subjected to a field amplified by the antenna according to the invention, such as a tomato, and a glass of water. The tomato is placed on the antenna. By proceeding in this manner, an electric and a magnetic current is induced inside the system constituted by the tomato.

Figure T15. The induction of electric current produced by a inductive vortex and a tomato.

Applying the antenna to the glass of water, the antenna is a resonance circuit, without any extra other component—apart from the resistance and the capacitance of the wire and the number of turns of the coil. This will produce an electric/magnetic effect to the molecules of water floating. In this manner the antenna causes an activation of the system water simply because the water is placed it in the proximity of this field.

The various possible geometries of antenna—and thus fields—come in from the perspective of the geometries that are found an inherent in the nature. For example, looking at the number of petals on a flower, the flower may have 2, 3, 4, 5, 6, 7, 8, 12 petals in the most common geometric shape. It is not clearly understood in science where these determined geometries in the flower originates from. The geometry is not determined by the gene. It is thought that this may be related with the way atoms become structured before even anything goes down to creating the genomes of the plant. Therefore this has to do with the electrical attractions between atoms, because we see that atoms are not randomly connected but they are actually connected in very specific shapes—this can especially well be seen in crystal structures.

Now by stimulating this global phenomena, we can imagine different types of shapes. So for example, a square shape. We have 2 parallel flows, running north-south and 2 parallel flows running east-west. So this is just a single pair wires, when we add water wire to this structure, we begin to increase the intensity if we connect these wires together, this single piece of wire, there is induction between these single these. But this time around, the frequency of this phenomena decreases, because we are lengthening the size of the antenna.

The frequency characteristic is related to the length of the antenna. The voltage and the current are related to the electric properties of the antenna. Concerning the electric properties, if we look for example at copper, electric property of copper: so if we look at the dielectric property, this is a semiconductor material that can be polarized by an applied electric field. Now the electric field is coming from it's induced field, naturally induced field. The charges, here, don't flow through the material. But it changes their position. It changes their position and this is called dielectric polarization. So it's not electric flow as we think current flowing through a wire but it is an electrical charge for example within space where a certain place or a certain area of the material will have a difference in charge. So for example, the center will have a more negative charge and the corners will have more positive charges. So, again this is a physical system. This is a 3D system where, electric charges, we can displace electric charges. So we can have literally, if you can imagine triangles, squares or pentagrams, we can have electric charge sitting in space, in a particular geometric configuration.

An object known as a dielectric resonator is an electrical component that exhibits resonance, for a narrow range of frequencies. This is frequently used to produce microwave range radiation. These dielectric resonators are called SAW (Surface Acoustic Wave) devices. SAW devices are used for example in mobile phones. The antenna according to the invention is also a particular embodiment of a SAW device, i.e., a physical cavity that resonates at specific frequencies in the Hz range Now extending the concept of the mobile phone into a huge (relatively to the mobile phone) volume where we create this resonance in the huge volume, compared to what is inside the mobile phone, this becomes a natural resonator. The geometry of SAW devices is well determined. Hence it is important to precisely plan the placement of the antenna, the interferences—the acoustic of the antenna's environment.

Different geometries of antennas will create different spatial manifestations of electric charges. Electric charges must de precisely positioned and quantified in different spaces. Similar to an electric circuit, where there are differences in electrical potential in the 2 dimensions of the circuit, when using the antenna we need to consider 3 dimensional space. We achieve differences of electrical potential within various spots in space.

When stimulating a tomato, we need to use an antenna having a geometric form of five corners. The reason for this is understood as follows: when cutting a tomato in half, it's internal structure appears to have 5 segments. This is constant and no tomato can be found that has only 4 or more than 5 segments inside. Similarly a cucumber appears to have a triangular structure inside. The general idea is that in order to stimulate a biological system, we apply a very specific antenna, i.e., substrate with conducting lanes on it laid out in a specific geometry adapted to stimulate mostly the resonances inside specific type of foods.

In summary the inventive antenna allows to stimulate biological systems through induction, because it induces electrical current with a specific voltage. Further the length of the antenna may be customized by changing the length of the electrical conductor, i.e., the conducting lanes on the substrate connected or not between each other, to be able to change the frequency of the inductive process of natural resonance. Also the effect of the antenna may be modulated by introducing in the antenna circuit a capacitor and a resistor, taking care to adjusting the capacitor and resistor values, and thereby selecting a very specific frequency at which the entire process will resonate.

Figure T16. An active version of the vortex inductor having a variable resistance and capacitance.

So 10 if this capacitor charges, discharges, affecting the dynamic not only of the electric current and voltage but then its related magnetic field. So that's 90 degrees out of a phase from the electric field. We can also imagine adding an additional conductor here, so we have inductive LRC circuits which is self powered by the inductive force of parallel lines. We could have a variable resistor, we can have a variable capacitor, we could have a variable inductor. We could adjust the properties of this circuit according to specific conditions. So, this is a naturally resonating circuit.

### DETAILED DESCRIPTION OF PREFERRED EMBODIMENTS

The invention consists of a disk or plate containing an etched, printed or glued conductive material in the form of a coil having a specific geometric shape. The natural flow of electrically charged particles, such as electrons or protons, that are plentiful in biological systems, activate the inductive properties of the inductive disk or antenna, and thus generate an induced electromagnetic signal in the coil. A variable resistor and variable capacitor can be added to the configuration, essentially creating and LRC circuit, allowing the system to oscillate at a specific frequency.

The invention consists of a flat electrically neutral surface upon which a conductive material may be placed, etched, printed or attached with an adhesive.

The conductive material is arranged in a manner where the individual wires or traces are arranged in parallel and follow a similar path towards the center of the electrically neutral surface having a smaller diameter with each turn or winding.

The conductive material, on the electrically neutral surface, is arranged according to a specific geometric shape.

The configuration of the windings of the conductive material on the flat electrically neutral surface function as an inductor.

The conductive material can be placed, etched, printed or attached with an adhesive on a fixed electrically neutral surface such as a electronic circuit board, glass, wood, ceramic or composite material.

The conductive material can be placed, etched, printed or attached with an adhesive on a flexible electrically neutral surface such as a plastic sheet, rubber pad, cloth or composite material.

The conductive material can be placed, etched, printed or attached with an adhesive on a fixed electrically neutral surface such as a electronic circuit board, glass, wood, ceramic or composite material, or on a flexible electrically neutral surface such as a plastic sheet, rubber pad, cloth or composite material, can be used as a passive antenna capable of transmitting and receiving wavelengths related to the size of the coil windings.

The conductive material can be placed, etched, printed or attached with an adhesive on a fixed electrically neutral surface such as a electronic circuit board, glass, wood, ceramic or composite material, or on a flexible electrically neutral surface such as a plastic sheet, rubber pad, cloth or composite material, can be used as an active antenna capable of transmitting and receiving wavelengths related to the size of the coil windings if a electronic oscillator is attached to the windings.

The conductive material can be placed, etched, printed or attached with an adhesive on a fixed electrically neutral surface such as a electronic circuit board, glass, wood, ceramic or composite material, or on a flexible electrically neutral surface such as a plastic sheet, rubber pad, cloth or composite material, can be used as an inductor having inductive properties related to the size of the coil windings.

The conductive material can be placed, etched, printed or attached with an adhesive on a fixed electrically neutral surface such as a electronic circuit board, glass, wood, ceramic or composite material, or on a flexible electrically neutral surface such as a plastic sheet, rubber pad, cloth or composite material, and combined with a fixed or variable resistor and a fixed or variable capacitor, can be used as a fixed or variable resonator having inductive properties related to the size of the coil windings and values of the resistor and capacitor.

1. An inductive disk or plate containing an etched, printed or glued conductive material in the form of a coil having a specific geometric shape, arranged such that the natural flow of electrically charged particles, such as electrons or protons, that are plentiful in biological systems, activate the inductive properties of the inductive disk or antenna, and thus generate an induced electromagnetic signal in the coil.

2. The inductive disk or plate of claim 1, further comprising a variable resistor and variable capacitor arranged such to creating an LRC circuit, allowing the system to oscillate at a specific frequency.

3. A flat electrically neutral surface upon which a conductive material is placed, etched, printed or attached with an adhesive, the conductive material being arranged in a manner where the individual wires or traces are arranged in parallel and follow a similar path towards the center of the electrically neutral surface having a smaller diameter with each turn or winding.

4. The device of claim 3, wherein the conductive material, on the electrically neutral surface, is arranged according to a specific geometric shape.

5. The device of claim 3, wherein the configuration of the windings of the conductive material on the flat electrically neutral surface function as an inductor.

6. The device of claim 3, wherein the fixed electrically neutral surface is an electronic circuit board, glass, wood, ceramic or composite material, or a flexible electrically neutral surface such as a plastic sheet, rubber pad, cloth or composite material,

7. Use of the device of claim 3 or 6 as an active antenna capable of transmitting and receiving wavelengths related to the size of the coil windings if a electronic oscillator is attached to the windings.

8. Use of the device of claim 2 as a fixed or variable resonator having inductive properties related to the size of the coil windings and values of the resistor and capacitor.

9. Use of the device of any one of claims 1 to 5 as a fixed or variable resonator having inductive properties related to the size of the coil windings and values of the resistor and capacitor that is electrically activated by the free electrical charges of fresh fruits and vegetables that are placed in contact with the device.

10. Use of the device of any one of claims 1 to 5 as a fixed or variable resonator having inductive properties related to the size of the coil windings and values of the resistor and capacitor that is electrically activated by the use of an external signal oscillator producing a signal at the resonant wavelength of the coil windings.

11. Use of the device any one of claims 1 to 5 as a fixed or variable resonator having inductive properties related to the size of the coil windings and values of the resistor and capacitor that is mounted inside a shipping or storage container for the transport or storage of fresh fruits and vegetables.

12. Use of the device of any one of claims 1 to 5 as a fixed or variable resonator having inductive properties related to the size of the coil windings and values of the resistor and capacitor that is printed on packaging materials such as paper, plastic or derivatives, that are in contact with fresh food products.

13. Use of the device of any one of claims 1 to 5 as a fixed or variable resonator having inductive properties related to the size of the coil windings and values of the resistor and capacitor that is imbedded into performance and sports related clothing, footwear and equipment.

14. Use of the device of any one of claims 1 to 5 as a fixed or variable resonator having inductive properties related to the size of the coil windings and values of the resistor and capacitor that is imbedded into therapeutic products such as patches, prosthetic devices, implants and equipment.

15. Use of the device of any one of claims 1 to 5 as a fixed or variable resonator having inductive properties related to the size of the coil windings and values of the resistor and capacitor that is imbedded into professional and consumer kitchen products such as storage bins, containers, packaging, cooking pots, frying pans, baking dishes, woks, glassware, and utensils.
